(19) United States
(12) Patent Application Publication
(10) Pub. No.: US 2006/0206874 A1
(43) Pub. Date: Sep. 14, 2006

(54) System and method for determining the cacheability of code at the time of compiling

(76) Inventor: Dean A. Klein, Eagle, ID (US)

Correspondence Address: Edward W. Bulchis, Esq.;DORSEY & WHITNEY LLP, Suite 3400, 1420 Fifth Avenue, Seattle, WA, 98101, US

(21) Appl. No.: 11/431,166

(22) Filed: May 9, 2006

Related U.S. Application Data
(63) Continuation of application No. 09/654,115, filed on Aug. 30, 2000.

(51) Int. Cl. G06F 9/45

(52) U.S. Cl. 717/136; 717/151

(57) ABSTRACT

A system and method for selectively enabling only certain information to be cached is provided which thereby increases the performance of a computer system by reducing cache hits and cache thrashing. The system and method determines and identifies at the time of compilation of a computer program, which program and instructions and/or data are to be cached or not cached, during the execution of the computer program. The system and method performs these determinations by first compiling a computer program, simulating the op erations of the program with suitable data parameters, and creating a profile of how the program code is utilized by the computer system. The profile is then utilized during a recompilation of the program code to determine which instructions and/or data is to be cached and which are not. The system preferably designates the cache status by affixing additional bits at the end of each instruction/data. During execution of a program code, a bus interface unit determines which instructions/data to cache, where to cache (i.e., level one or a higher level cache), and how to cache (e.g., write through or write back).

### TECHNICAL FIELD

The present invention relates to cache memory for computer systems and, more specifically, to a system and method for compile-time cacheability determinations.

### BACKGROUND OF THE INVENTION

A cache-memory system is an integral tool used by computer designers to increase the speed and performance of modern computers. As processor speeds have increased more rapidly than main-memory speeds in recent years, cache memory systems have become even more important. By avoiding unnecessary accesses to the comparatively slow main memory, an efficient cache-memory system can increase overall system speed dramatically.

In general, cache-memory systems have been designed based on the computer-science principle that a processor is more likely to need information it has recently used rather than a random piece of information stored in a memory device. Accordingly, when a processor issues a read command for particular instructions and/or data, the processor checks the cache to determine if the desired instructions/data are in the cache. If so (a cache “hit”), the processor accesses the instructions/data from the cache, and minimizes the amount of processing speed that is wasted accessing the main memory. If not (a cache “miss”), the processor accesses the desired instructions/data from main memory and writes those instructions/data into the cache (thereby overwriting less recently used information in the cache). Thus, at any given time, the most-recently used instructions/data generally reside in the cache.

Although this system of caching is effective in increasing overall computer-system speed for most applications, it can also be detrimental in some circumstances. For example, caching all of the most recently used instructions/data may lead to more cache misses than hits, and the execution of certain computer programs and/or subroutines may lose much or all of the speed benefit of caching. In addition, depending on the particular cache-management scheme employed by a computer system, the traditional caching algorithm may cause the cache to be “thrashed.” Thrashing of the cache refers generally to one snippet of instructions/data repeatedly being swapped in and out of the cache for another snippet of instructions/data. This can be caused, for example, by certain code subroutines that call for repeated instruction loops. Thrashing of a cache can severely limit overall computer-system speed-sometimes to the point of making the system intolerably slow.

Therefore, there is a need for a refined system and method for caching instructions/data based on criteria beyond simply the most-recently used instructions/data thereby maximizing cache hits and preventing cache thrashing.

### SUMMARY OF THE INVENTION

The present invention provides an improved system and method for selectively enabling only certain information to be cached based on a variety of factors designed to increase cache hits and avoid cache thrashing. During compilation of a computer program, program instructions and/or data are marked as cacheable or non-cacheable. Instructions/data that are not likely to be recalled by the processor during execution of the computer program are marked as non-cacheable. In addition, instructions/data that, if cached, are likely to cause thrashing are also marked as non-cacheable. During execution of the computer program, cache hits are thus increased and cache thrashing is substantially reduced. According to one aspect of the invention, the information can also be marked to direct in which of several caches (e.g., level-one cache or level-two cache) and how (e.g., write-back vs. write-through) eligible information is cached.

### BRIEF DESCRIPTION OF THE DRAWINGS

FIG. 1 is a simple block diagram representing a computer system implementing the preferred embodiment of the present invention.

FIG. 2 is a flow chart depicting the methodology utilized and the software executed in the computer system of FIG. 1.

FIG. 3 is a flow chart depicting the basic compilation operation performed in the computer system of FIG. 1 in accordance with one embodiment of the invention.

FIG. 4 is a flow chart depicting the typical instruction fetch routine performed in the computer system of FIG. 1 in accordance with one embodiment of the invention.

FIG. 5 is a flow chart depicting a typical data write process performed in the computer system of FIG. 1 in accordance with one embodiment of the invention.

### DETAILED DESCRIPTION OF THE INVENTION

A preferred embodiment of a system and method according to the present invention utilizes a compile-time determination of cacheability to increase the speed and reliability of a computer system. Because computer programs are commonly written in a high level language (for example, the computer language “C”) and utilize source codes which are then converted into a machine's object code by a compiler, computer programs are often not written in a way which optimizes the performance of a computer executing the program. As is commonly known in the art, various compilers often attempt to optimize computer programs. For example, optimization can be based on particular rules or assumptions (e.g., assuming that all “branches” within a code are “taken”), or can be profile-based. When performing profile-based optimizations (“PBO”), the program code is converted into object code and then executed under test conditions. While executing the object code, profile information about the performance of the code is collected. That profile information is fed back to the compiler, which recompiles the source code using the profile information to optimize performance. For example, if certain procedures call each other frequently, the compiler can place them close together in the object code file, resulting in fewer instruction cache misses when the application is executed.

The present embodiment of the invention makes novel use of the optimizing capabilities of modem compilers by adding cacheability bits to instructions and data at compile-time. “Cacheability,” as used herein, refers to several cache-related variables, including: whether certain information is cacheable; where certain information is cacheable (e.g., level-one cache or level-two cache); and how that information is cacheable (e.g., write-back or write-through). By limiting the instructions/data that can be cached during execution and specifying where and how that information is to be cached, cache hits are increased and the risk of cache thrashing is greatly reduced. Other advantages will be apparent from the preferred embodiment will be discussion below.

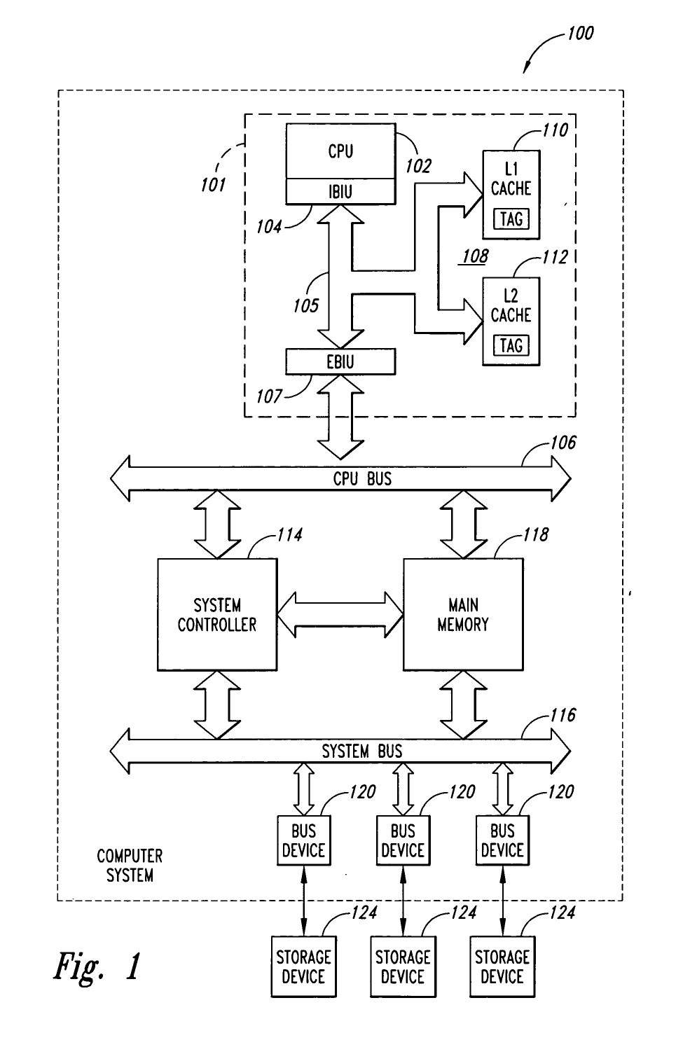

FIG. 1 is a simplified block diagram of one embodiment of a computer system 100 according to the present invention. FIG. 1 is merely exemplary, and those of skill in the art will recognize that several elements shown in FIG. 1 could be combined or altered, and different computer architectures could be used. In the exemplary embodiment shown, the computer system 100 includes a processing system 101 that includes a central processing unit (CPU) 102 includes an internal bus interface unit (“IBIU”) 104, which communicates with a CPU bus 106 through an internal bus 105 and an external bus interface unit (“EBIU”) 107. The EPIU 107 includes standard circuitry to decode instructions and format information to be placed on the CPU bus 106.

The computer system 100 also includes cache circuitry 108. Almost all modern processors include at least one level-one (L1) cache 110, which resides on the same chip as the CPU 102. Many processors also use, however, level-two (L2) caches 112, which are significantly larger than L1 caches 110 and either on-chip or reside off-chip. The L2 cache 112 is shown in FIG. 1 as being on-chip. Preferred cache circuitry is disclosed in U.S. Pat. No. 5,829,036, which is incorporated herein by reference. As disclosed in that patent, the cache circuitry preferably includes a cache connector (not shown) and multiplexer (not shown) to permit the easy addition of an L2 cache. Although single L1 and L2 chaches 110, 112 are shown in FIG. 1, it will be understood that the L1 cache 110 and/or the L2 caches 112 may be separate instruction and data caches (not shown).

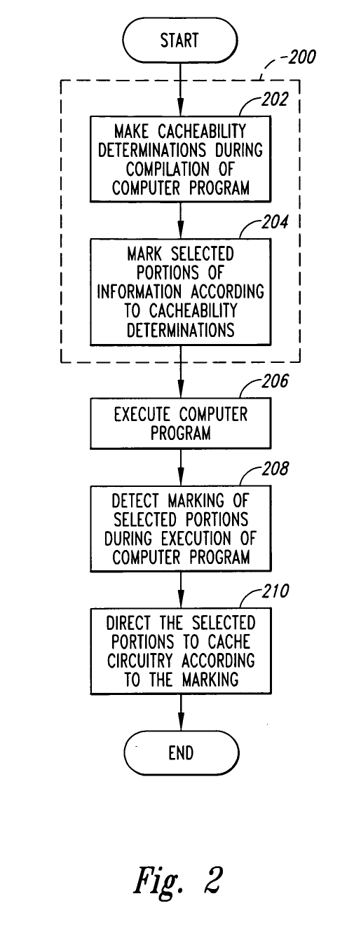

The computer system 100 also includes a system controller 114, which communicates between the CPU bus 106, a system bus 116, and a main memory 118. Typically, input and output devices (not shown) as well as additional storage devices 124 are connected to the system bus 116 through appropriate bus devices 120. The operation of the computer system depicted in FIG. 1 will be described in greater detail with relation to FIGS. 2-5 below.

FIG. 2 is a simplified flow chart showing one embodiment of a method and computer program for operating the computer system 100 according to the present invention. A computer program 200 includes code 202 for making cacheability determinations for information associated with the computer program, and code 204 for marking at least selected portions of the information according to the determinations. Once the information is appropriately marked for cacheability, the computer program is executed at 206 on the computer system 100, which includes the cache circuitry 108. As mentioned above, the computer program 200 may be executed on computer systems having architectures other than the architecture of the computer system 100 shown in FIG. 1. Finally, during execution of the computer program, the marking of the selected portions of the information are detected at step 208, and those selected portions of the information are directed to the cache circuitry pursuant to the marking at step 210.

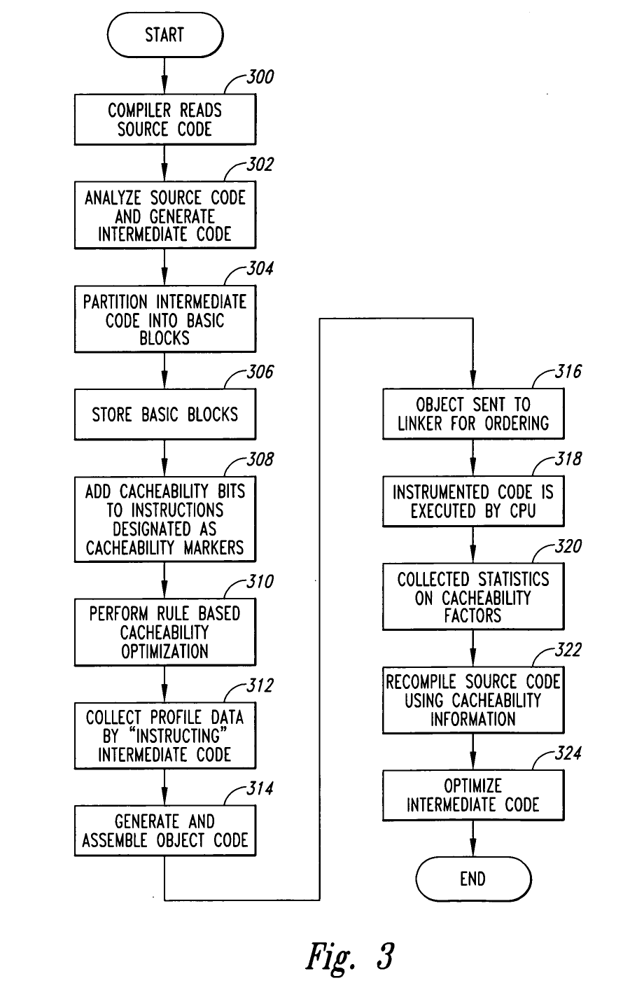

An example of a procedure by which the computer system 100 (FIG. 1) can compile the source code as shown in FIG. 3. The source code, which is either stored in main memory 118 or imported from an external storage device 124, is initially read by the compiler at step 300. As discussed, the source code is written in a humanly readable computer language, such as C. Upon receiving the source code, the compiler generates an intermediate code utilizing an analyzer at step 302. Analyzers utilized in compilers are well known in the art and include lexical analyzers, syntax analyzers, and semantic analyzers. The compiler may be configured to utilize any of these analyzers or others in performing its operations. After the source code has been analyzed and an intermediate code generated, the compiler partitions the intermediate code it into basic blocks at step Block 304.

Typically, each function and procedure in the intermediate code is represented by a group of related basic blocks. As is commonly understood in the art, a basic block is a sequence of consecutive statements in which flow of control enters at the beginning and leaves at the end without any branching occurring within the block and only at the end of the basic block. The basic blocks of the intermediate code are then stored by the compiler into basic block data structures at step 306.

In its most simple embodiment, inner loops alone may be marked as cacheable. One step more complicated would be to expand cacheability to outer loops, first analyzing all loops and referenced addresses for their relative offsets - which would indicate a possible thrashing condition. Cache associativity needs to be considered. This analysis requires linker interaction.

Once the basic blocks have been identified, the compiler then preferably adds bits to the end of each instruction that will function as cacheability markers at step 308. For example, if it is desired to control whether, where, and how each instruction is cached, three bits could be provided, thereby allowing control over: (1) whether to cache; (2) where to cache (L1 or L2); and (3) how to cache (write-back or write-through)). It will be apparent to those skilled in the art that additional or fewer variables could be similarly controlled by the addition of more or less cacheability bits. Also, the cacheability marker bits may alternatively be added at locations other than the end of each instruction, such as being encoded in op codes.

The optimization portion of the compiler's back end then performs rule-based cacheability optimizations using the newly-added cacheability bits at step 310. For example, it is generally desirable not to allow interrupt-service routines to be cached because they are not likely to be repeated. In addition, any snippets of code that need to be controlled in real-time should not be cached because there is no way to predict during execution whether those snippets will be in the cache until they are accessed. Other instructions may be cacheable, but are not likely to be recalled during execution often enough to warrant level-one caching. Those snippets of code may be marked (e.g., by setting the second cacheability bit to zero) to be cacheable only to the level-two cache. Accordingly, the optimization portion of the compiler's back end preferably performs rule-based cacheability optimizations before collecting profile data. Preferably, as mentioned previously, this optimization process is accomplished by setting cacheability bits at the end of each instruction. Additionally, the compiler may be configured to perform various other optimizations commonly known in the art. For example, rule-based direct branch prediction heuristics can be employed as desired.

The compiler also “instruments” the intermediate code to collect profile data at step 312. As is commonly known in the art, instrumentation of code refers to the process of adding code that writes specific information to a log during execution and allows a compiler to collect the minimum specific data required to perform a particular analysis. Similarly, the compiler may also utilize general purpose trace tools to collect data. General purpose trace tools are commonly known in the art and are not discussed in detail herein. Other presently existing or future developed techniques may alternatively be used to collect profile data. Nevertheless, for the preferred embodiment, the compiler is instructed to collect the desired cacheability information by specifically instrumenting the code. At this point, the compiler generates and assembles the object code at step 314 using processes and techniques commonly known in the art.

The object code is then preferably sent to the linker at step 316. The linker links and appropriately orders the object code according to its various functions to create an instrumented executable object code. Those skilled in the art will recognize that the object code can also be directly instrumented by a dynamic translator. In that instance the compiler need not instrument the intermediate code. As used herein, “instrumenting” refers broadly to any method by which the code is arranged to collect data relevant to cacheability, including both dynamic translation and instrumentation during compilation.

The instrumented executable code is executed by the CPU using representative data at step 319. Preferably, the representative data is as accurate a representation as possible of the typical workload that the source code was designed to support. Use of varied and extensive representative data will produce the most accurate profile data regarding cacheability. During execution of the instrumented executable code using representative data, statistics on cacheability-related factors are collected at step 320. These factors are discussed at greater length below. This collection, or “trace”, of cacheability statistics is enabled by the instrumentation of the object code and can be accomplished in a variety of ways known in the art, including as a subprogram within the compiler or as a separate program stored in memory. It will also be recognized by those of ordinary skill in the art that the instrumentation of code and collection of profile data can be performed at the same time profile data on other factors (e.g., direct branches) are being generated and collected.

After cacheability profile data is collected, it is sent back to the compiler where the source code is recompiled using that information at step 322. It is possible that, when the source code was originally translated to intermediate code during the original compilation, the intermediate code was saved in memory. If this is true, the front end compilation need not be repeated to generate an intermediate code from the source code. As used herein, therefore, “recompiling the source code” refers to recompiling directly from the source code, recompiling from the intermediate code generated during some previous compilation, or some other process that provides equivalent results. If the intermediate code was not previously saved, the front end of the compiler again translates the source code into an intermediate code. The intermediate code then enters the back end of the compiler where it is analyzed and partitioned into basic blocks as previously described.

Once the intermediate code has been broken into basic block data structures, it is optimized at step 324. The optimization during recompilation, however, is more intricate and, as is appreciated by those skilled in the art, can be performed utilizing any of a number of well known sequences to achieve the same result. In addition, it will be appreciated that although the compile and recompile steps may differ, they can and usually will be accomplished by different subprograms or combinations of subprograms in the same compiler.

At this point, the source code has been appropriately marked for cacheability and is ready to be compiled and executed by the computer system 100 (FIG. 1). As is readily apparent to those skilled in the art, by utilizing the optimized cacheability bits, the computer program will run more efficiently by minimizing the thrashing of the cache.

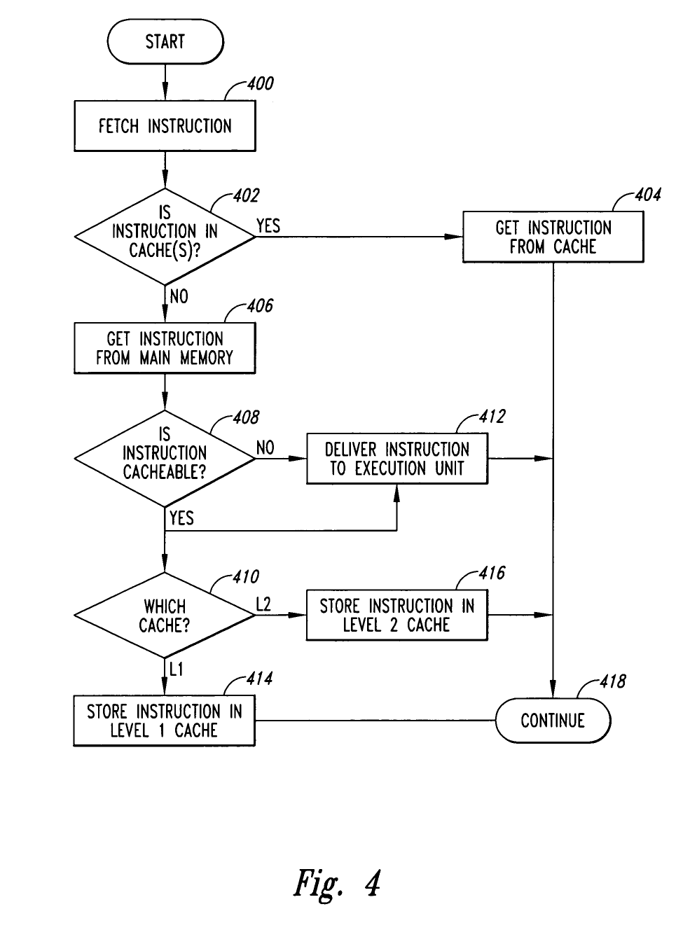

FIG. 4 is a flow chart showing a typical instruction fetch 400 for a computer program that has been optimized according to one embodiment of the present invention. The CPU 102 (FIG. 1) calls for an instruction fetch and first checks in the cache circuitry 108 at step 402 to see if the desired instruction is stored there. This check is made by first checking the L1 cache 110 for a cache hit, and, if there is a cache miss in the L1 cache 110, then checking the L2 cache 112 for a cache hit. If the desired instruction is checked, the IBIU 104 obtains the desired instruction from the cache circuitry 108 at step 404. If not, the IBIU 104 retrieves the desired instruction from the main memory 118 at step 406.

Once the instruction is retrieved from either the cache circuitry 108 or the main memory 118, the IBIU 104 check the cacheability bits that have been previously set by the compiler in step 408, as described above. If the instruction is indicated as cacheable, the IBIU 104 checks at step 410 whether the instruction is cacheable in the level-one cache 110 or only in the level-two cache 112. Preferably in parallel, the IBIU 104 also delivers the instruction to the execution unit of the CPU at step 412. If the instruction is cacheable in the level-one cache 110, it is stored there at step 414. Similarly, if the instruction is indicated as cacheable in only the level-two cache 112, it is stored there at step 416. The CPU 102 then continues to its next task via 418. As may be appreciated by those skilled in the art, the before mentioned process may also be utilized when determining whether to cache data, parameters, operands, and other variables. Similarly, the number of caches utilized by a computer system may be increased or decreased and cacheability determination suitably modified, as necessary. As such, the principles of the present invention can be applied to any type of data streams or instructions, and to any system configuration.

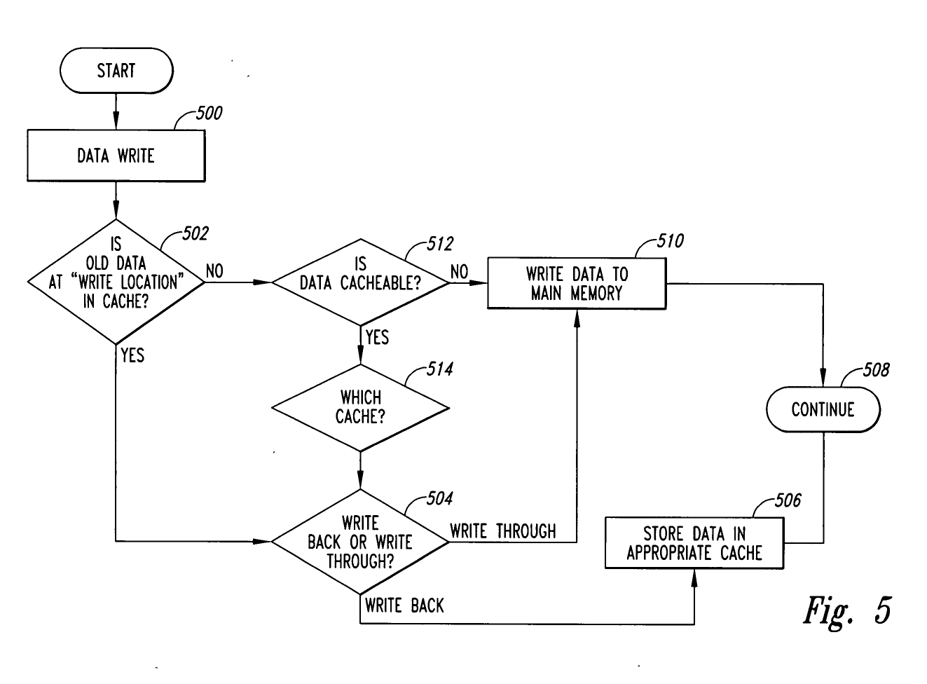

FIG. 5 is a flow-chart showing a typical data write 500 by the CPU 102 using one embodiment of the cacheability system of the present invention. The IBIU 104 first checks at 502 to determine whether there is data in the cache circuitry 108 corresponding to the address in main memory 118 to which the new data is to be written. If so, the IBIU 104 checks the cacheability bits of the data in the cache circuitry 108 at step 504 to determine if it is set for write-back or write-through caching. If a bit indicative of write-back caching has been detected, the data is stored at step 506 in the appropriate cache (L1 110 or L2 112 depending on the marking), and the CPU 102 continues to its next task via 508. If a bit indicative of write-through caching is detected at 504, the new data is also stored in main memory 118 at step 510 in parallel with storage in the appropriate cache at step 506, and processing continues via 508.

If no data corresponding to the data-write address in main memory 118 is detected in the cache circuitry 108 at step 502, the IBIU 104 determines at step 512 whether the new data is cacheable. If not, the data is simply written to main memory 118 at step 510, and the CPU 102 continues to its next task via 508. If the data is cacheable, the IBIU 104 determines in which cache (L1 cache 110 or L2 cache 112) to store the data at step 514, determines how to cache the data at step 504), stores the data appropriately in the cache at step 506 and also in the main memory 118 at step 510 in the case of write through caching), and continues its processing via 508. It will be recognized by those skilled in the art that many processors do not cache data writes, so some of the above-described steps may not be necessary in some computer systems.

While the present invention has been disclosed in conjunction with a preferred embodiment, the scope of the present invention is not to be limited to one particular embodiment, process, methodology, or flow. Modification may be made to the process flow, techniques, system, components used, and any other element, factor, or step without departing from the scope of the present invention.

1. A computer system having cache circuitry, the computer system adapted to be controlled by a computer program to cache information, comprising:
cache circuitry, including a cache memory adapted to store information related to a computer program;
a main memory adapted to store the information;
a processor adapted to be controlled by the computer program and adapted to cooperate with a bus interface unit to direct selected portions of the information to the cache circuitry based at least in part on cacheability determinations made during compilation of the computer program; and
bus circuitry, operatively connecting the processor, the cache circuitry, and the main memory.

2-61. (canceled)
